(19) United States
(12) Patent Application Publication
(10) Pub. No.: US 2007/0022226 A1
(43) Pub. Date: Jan. 25, 2007

(54) Direct memory access system for iSCSI

(76) Inventors: Zheng-Ji Wu, Hsinchu (TW); Han-Chiang Chen, Hsinchu (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/312,479

(22) Filed: Dec. 21, 2005

(30) Foreign Application Priority Data
Jul. 19, 2005 (TW) 094124296

(51) Int. Cl. G06F 13/28

(52) U.S. Cl. 710/22

(57) ABSTRACT

The invention relates to a direct memory access system for iSCSI. The direct memory access system comprises: a first bus interface, a second bus interface, a FIFO memory, an iSCSI CRC module and a direct memory access controller. According to the invention, the iSCSI CRC module is mounted in the direct memory access system to automatically calculate the iSCSI cyclic redundancy codes and update the digest of the iSCSI protocol data unit during directly accessing the iSCSI protocol data unit between the iSCSI protocol and the TCP/IP protocol. Therefore, the direct memory access system of the invention can reduce the loading of CPU and the latency of repeatedly reading the iSCSI protocol data unit so as to raise the speed and efficiency for processing the iSCSI cyclic redundancy codes and to reduce the reading memory time and the waiting time.

### BACKGROUND OF THE INVENTION

1. Field of the Invention

The invention relates to a direct memory access system, and more particularly, to a direct memory access system for iSCSI.

2. Description of the Related Art

The iSCSI is a newly developed storage network technology and transport protocol. The main function of the transport protocol is to transmit the instruction and data of the SCSI on the IP network, which has been well developed nowadays, through the iSCSI PDU. The IP network may also become a storage network through iSCSI protocol.

The biggest advantage of IP network as a storage network for the users is that inexpensive and good storage network may be built by only replacing its server and storage equipment with the iSCSI interface, while still using the switch equipment of the original IP network.

In the loading analysis for the iSCSI protocol, it is found that the loading of the TCP/IP transmitting and receiving is the largest, and the next largest loading is the operation of iSCSI CRC (cyclic redundancy codes). Since the operation of the iSCSI CRC is repeated and needs to consume much CPU processing time, it is proper to accomplish the operation of iSCSI cyclic redundancy codes by hardware instead. But if the iSCSI CRC operation is processed solely by iSCSI CRC module after the iSCSI CRC operation is accomplished by hardwarized module, there must be the reading memory time and the waiting time. Therefore, solely hardwarized iSCSI CRC module cannot achieve the best efficiency.

Conventional direct memory access (DMA) system is the technology put forward for a very long time and mostly used as the hardware tool to transit data. With reference to the U.S. publication No. 20040123013, entitled “Direct memory access controller system”, this conventional patent application discloses that the calculation of error detection codes (EDCs) is embedded in at the same time of DMA data processing, so as to reduce the additional time of calculating EDC. However, it is directed to EDC calculation of a single data block, and uses the message format of DMA to initiate DMA and determines the operating codes and calculation of EDC. And then the calculated EDC value is used to transmit the calculated results by utilizing the DMA Response Message.

Also, the conventional technology supposes that there is only a single data block. If the data has a plurality of blocks, the number of interruptions of the DMA system will increase.

Therefore, it is necessary to provide direct memory access system to solve the problems described above.

### SUMMARY OF THE INVENTION

The invention provides a direct memory access system for iSCSI. The direct memory access system comprises a first bus interface, a second bus interface, a FIFO memory, an iSCSI CRC module and a direct memory access controller. The FIFO memory is connected to the first bus interface and the second bus interface. The iSCSI CRC module is connected to the FIFO memory, to obtain an iSCSI protocol data unit (PDU) by the FIFO memory. A cyclic redundancy code is calculated according to the iSCSI PDU. The direct memory access controller is connected to the FIFO memory and the iSCSI CRC module to control the operation of the FIFO memory and the iSCSI CRC module.

According to the invention, the iSCSI CRC module is mounted in the direct memory access system so as to reduce the reading memory time and the waiting time and raise the speed and efficiency for processing the iSCSI cyclic redundancy codes. Therefore, in the design architecture of the high-speed iSCSI host bus adapter (HBA), the direct access memory access system of the invention may process the iSCSI cyclic redundancy codes more efficiently. The direct memory access system of the invention provides a data transmitting interface for the iSCSI protocol and TCP/IP protocol so as to automatically produce the iSCSI cyclic redundancy codes and update the digest of the iSCSI protocol data unit when the DMA transmits the iSCSI protocol data unit is directly accessed. A rapid and high efficient iSCSI CRC processing can be achieved without influencing the original iSCSI protocol and TCP/IP protocol. Therefore, the direct memory access system of the invention can reduce the loading of CPU and the latency for repeatedly reading the iSCSI protocol data unit so as to raise the speed and efficiency for processing the iSCSI cyclic redundancy codes.

### BRIEF DESCRIPTION OF THE DRAWINGS

FIG. 1 is the schematic view of the direct memory access system for iSCSI, according to the invention;

FIG. 2 shows the schematic view of utilizing the direct memory access system of the invention to directly access iSCSI protocol data unit between the iSCSI protocol and TCP/IP protocol;

FIG. 3 is the schematic view of the iSCSI CRC module of the invention; and

FIG. 4 is the schematic view of the data processing flow of the CRC control module of the invention.

### DETAILED DESCRIPTION OF THE INVENTION

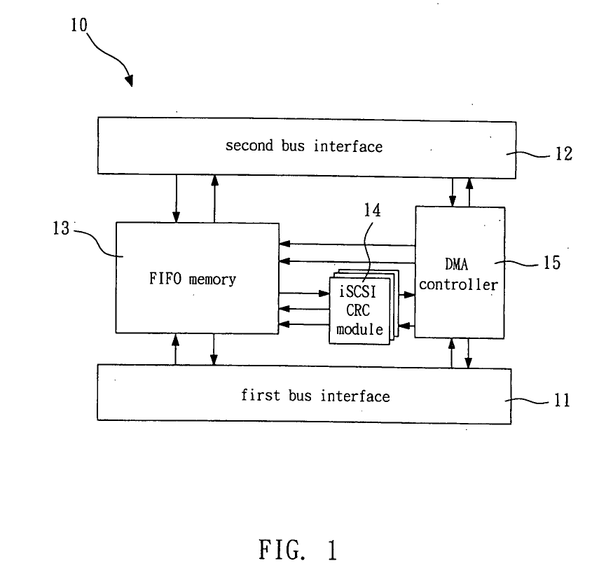

With reference to FIG. 1, it shows the schematic view of the direct memory access system for iSCSI, according to the invention. The direct memory access system 10 for iSCSI comprises: a first bus interface 11, a second bus interface 12, a FIFO memory 13, an iSCSI CRC module 14 and a DMA controller 15. The first bus interface 11 is a host bus interface. The second bus interface 12 is an application specific integrated circuit (ASIC) bus interface.

The FIFO memory (first-in-first-out memory) 13 is connected to the first bus interface 11 and the second bus interface 12. The FIFO memory 13 comprises a plurality of memory unit groups, each of which comprises a write memory unit and a read memory unit. The write memory unit is used for storing the data from the first bus interface 11 or the second bus interface 12, and the read memory unit is used for storing the data read out to the first bus interface 11 or the second bus interface 12.

The iSCSI CRC module 14 is connected to the FIFO memory 13 to obtain an iSCSI protocol data unit by the write memory unit of the FIFO memory 13. A cyclic redundancy code is calculated according to the iSCSI protocol data unit. The DMA controller 15 is connected to the FIFO memory 13 and the iSCSI CRC module 14 to control the operation initiated by the FIFO memory 13 and the iSCSI CRC module 14. The DMA controller 15 may transmit a request signal for reading data from or writing data into the first bus interface 11 and the second bus interface 12.

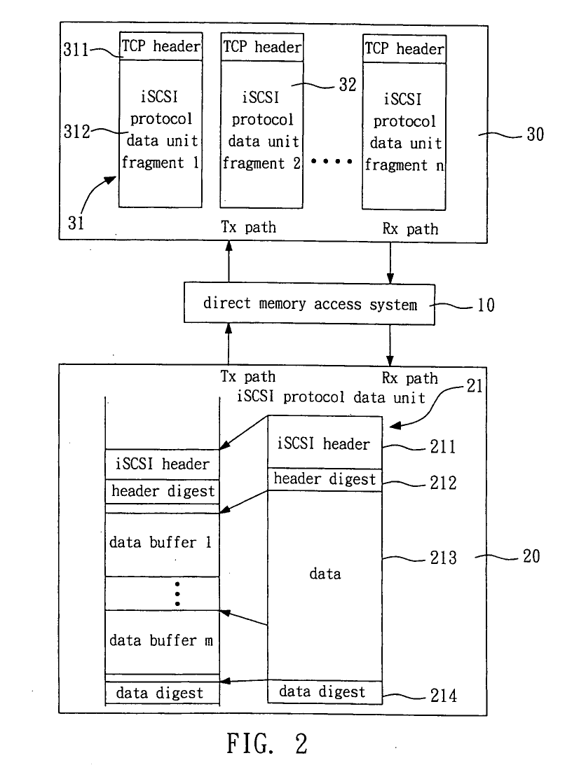

With reference to FIG. 2, it shows the schematic view of directly accessing the iSCSI protocol data unit between the iSCSI protocol and TCP/IP protocol by utilizing the direct memory access system 10 of the invention. The iSCSI protocol data unit 21 produced in the iSCSI protocol processing block 20 comprises: iSCSI header 211, header digest 212, data 213 and data digest 214. The data 213 in the iSCSI protocol data unit 21 may be consisted of a plurality of data buffers. It is determined whether to provide the function of header digest 212 and data digest 214 in the iSCSI protocol data unit 21 during iSCSI negotiation, and only when there exists data 213, the data digest 214 needs to be calculated. Additionally, the iSCSI protocol data unit 21 may only have the iSCSI header 211.

The iSCSI protocol data unit 21 in the iSCSI protocol is transmitted into the TCP/IP protocol processing block 30, so that the data of the iSCSI protocol data unit 21 is distributed into one or more TCP protocol data units 31, 32 by the direct memory access system 10. Each TCP protocol data unit comprises TCP header and iSCSI protocol data unit fragment. Taking the first TCP protocol data unit 31 as an example for illustration, the first TCP protocol data unit 31 comprises: TCP header 311 and iSCSI PDU first fragment 312 (iSCSI PDU fragment 1).

When the data is transmitted to the TCP/IP protocol by the iSCSI protocol (i.e. in transmitting mode, Tx mode), the data of one single iSCSI protocol data unit is distributed to one or more TCP protocol data units by the direct memory access system 10 of the invention, and a cyclic redundancy code, which will replace the existing data digest or header digest in the iSCSI protocol data unit, is calculated according to the iSCSI protocol data unit.

When the data is transmitted to the iSCSI protocol by the TCP/IP protocol (i.e. the receiving mode, Rx mode), one or more TCP protocol data units are sent into the iSCSI protocol data unit by the direct memory access system 10, and a cyclic redundancy code, which will be compared with the data digest or header digest in the iSCSI protocol data unit, is calculated according to the iSCSI protocol data unit. If they are identical, the data digest or the header digest will be set to 0; if different, the data digest or the header digest will not be changed.

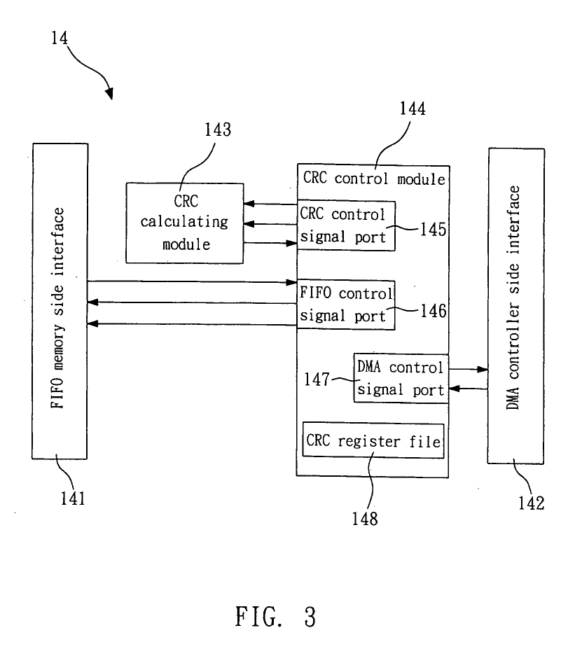

With reference to FIG. 3, it is the block schematic view of the iSCSI CRC module 14. The iSCSI CRC module 14 comprises: a FIFO memory side interface 141, a DMA controller side interface 142, a CRC calculating module 143 and a CRC control module 144. The FIFO memory side interface 141 accesses the data or control signal to the FIFO memory 13. The DMA controller side interface 142 accesses the data or control signal to the DMA controller 15, that is, the control signal from the DMA controller 15 is transmitted to the CRC control module 144; or the control and status signal of the CRC control module 144 is received and transmitted to the DMA controller 15.

The CRC calculating module 143 is used to calculate the cyclic redundancy codes of the iSCSI protocol data unit. The CRC controller module 144 controls the operation of the CRC calculating module 143, and controls the FIFO memory side interface 141 and the DMA controller side interface 142. The CRC control module 144 comprises: a CRC control signal port 145, a FIFO control signal port 146, a DMA control signal port 147 and a CRC register file 148.

The CRC control signal port 145 controls the operation of the CRC calculating module 143. The CRC control signal port 145 comprises: a CRC output control port, a CRC output data port and a CRC input data port. The CRC output control port resets the value of the cyclic redundancy codes calculated by the CRC calculating module 143, initiates the CRC calculating module 143 to start calculating the cyclic redundancy codes, and controls accessing the calculated cyclic redundancy codes from the CRC calculating module 143.

The CRC output data port transmits the required data to the CRC calculating module 143. The CRC input data port obtains the cyclic redundancy codes calculated by the CRC calculating module 143.

The FIFO control signal port 146 comprises: a FIFO data input port, a FIFO data output port and a FIFO output control port. The FIFO data input port reads the iSCSI protocol data unit of the write memory unit in the FIFO memory 13. The FIFO data output port writes the modified iSCSI protocol data unit into the read memory unit in the FIFO memory 13. The FIFO output control port transmits the reading or writing control signal to the FIFO memory 13.

The DMA control signal port 147 comprises: a DMA input control port and a DMA output control port. The DMA input control port receives the control message transmitted by the DMA controller 15, determines whether to calculate the header digest of the iSCSI protocol data unit or not, determines whether to calculate the data digest of the iSCSI protocol data unit or not, sets the size of the header of the iSCSI protocol data unit, sets the position of the data of the iSCSI protocol data unit in the FIFO memory 13, judges whether the DMA controller 15 has moved the data into the write memory unit of the FIFO memory 13 or not, sets the current DMA mode as the Tx mode or Rx mode, and obtains the state of the CRC control module 144. The DMA output control port transmits the response signal to the DMA controller 15.

The CRC register file 148 comprises a CRC control register and a CRC state register. The CRC control register stores the setting of the current DMA controller 15, whether to start the calculation of the header digest of the iSCSI protocol data unit currently, whether to start the calculation of the data digest of the iSCSI protocol data unit currently, the header size of the currently processed iSCSI protocol data unit and the current position of the data of the iSCSI protocol data unit in the FIFO memory 13. The CRC state register stores the current processing state of the CRC control module 144.

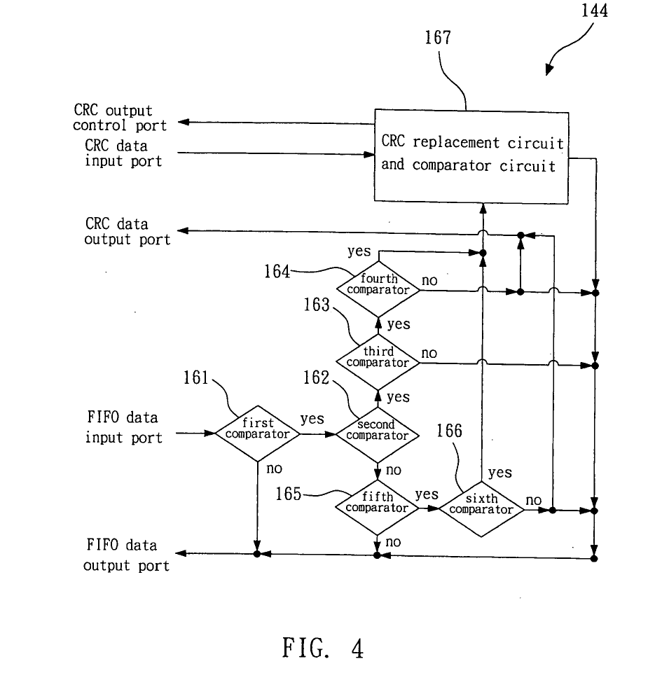

With reference to FIG. 4, it shows the schematic view of the data processing flow of the CRC control module 144. The CRC control module 144 further comprises: a first comparator 161, a second comparator 162, a third comparator 163, a fourth comparator 164, a fifth comparator 165, a sixth comparator 166, a CRC replacement and comparator circuit 167. Firstly, the FIFO data input port reads the data of the iSCSI protocol data unit. The first comparator 161 judges whether to start the operation of the iSCSI cyclic redundancy codes or not. If negative, the data would be written back into the FIFO data output port. If positive, the second comparator 162 judges whether the current data of the iSCSI protocol data unit is the header. If it is the header, it proceeds to the third comparator 163; if it is not the header but the data, it proceeds to the fifth comparator 165.

The third comparator 163 judges whether to start the operation of the CRC of the header. If negative, the data would be written back into the FIFO data output port; if positive, it proceeds to the fourth comparator 164. The fourth comparator 164 judges whether there is a header digest. If negative, the data would be written back into the FIFO data output port; if positive, the data would be transmitted to the CRC calculating module 143 so as to calculate the cyclic redundancy codes.

The fifth comparator 165 judges whether to start the operation of the CRC of the data. If negative, the data would be written back into the FIFO data output port; if positive, it proceeds to the sixth comparator 166. The is sixth comparator 166 judges whether there is a data digest. If negative, the data would be written back to the FIFO data output port; if positive, the data is transmitted to the CRC calculating module 143 to calculate the cyclic redundancy codes.

The CRC replacement and comparator circuit 167 receives the cyclic redundancy codes calculated by the CRC calculating module 143. Under Tx mode, the cyclic redundancy codes would replace the value of the existing data digest or header digest in the iSCSI protocol data unit; under Rx mode, the cyclic redundancy codes are compared with the data digests or the header digests in the iSCSI protocol data unit. If they are identical, the data digests or the header digests would be set to 0; if they are different, the data digests or the header digests would not be changed, and the modified iSCSI protocol data unit is transmitted to the FIFO data output port so as to be written into the read memory unit of the FIFO memory 13.

The direct memory access system 10 of the invention provides the data transmitting interface for the iSCSI protocol and TCP/IP protocol so as to automatically produce the iSCSI cyclic redundancy codes and update the digest of the iSCSI protocol data unit during directly accessing the iSCSI protocol data unit. It can provide rapid and high efficient iSCSI CRC processing without influencing the original iSCSI protocol and TCP/IP protocol. Therefore, the direct memory access system of the invention can reduce the loading of CPU and the latency of repeatedly reading the iSCSI protocol data unit so as to raise the speed and efficiency for processing the iSCSI cyclic redundancy codes.

While an embodiment of the present invention has been illustrated and described, various modifications and improvements can be made by those skilled in the art. The embodiment of the present invention is therefore described in an illustrative, but not restrictive, sense. It is intended that the present invention may not be limited to the particular forms as illustrated, and that all modifications which maintain the spirit and scope of the present invention are within the scope as defined in the appended claims.

What is claimed is:

1. A direct memory access system for iSCSI, comprising:
a first bus interface;
a second bus interface;
a FIFO memory interface, connected to the first bus interface and the second bus interface;
an iSCSI CRC module, connected to the FIFO memory so as to obtain an iSCSI protocol data unit by the FIFO memory, and a cyclic redundancy code calculated according to the iSCSI protocol data unit; and
a DMA controller, connected to the FIFO memory and the iSCSI CRC module to control the operation of the FIFO memory and the iSCSI CRC module.

2. The direct memory access system according to claim 1, wherein the first bus interface is a host bus interface.

3. The direct memory access system according to claim 1, wherein the second bus interface is an ASIC bus interface.

4. The direct memory access system according to claim 1, wherein the FIFO memory comprises a plurality of memory unit groups, each memory unit groups comprises a write memory unit and a read memory unit, the write memory unit storing the data from the first bus interface or the second bus interface, and the read memory unit storing the data read out to the first bus interface or the second bus interface.

5. The direct memory access system according to claim 4, wherein the iSCSI CRC module comprises:
a FIFO memory side interface, accessing the data of the FIFO memory;
a DMA controller side interface, accessing the data of the DMA controller;
a CRC calculating module, calculating the cyclic redundancy code of the iSCSI protocol data unit; and
a CRC control module, controlling the operation of the CRC calculating module, and controlling the FIFO memory side interface and the DMA side interface.

6. The direct memory access system according to claim 5, wherein the CRC control module comprises:
a CRC control signal port, controlling the CRC calculating module;
a FIFO memory control signal port, controlling reading the iSCSI protocol data unit of the write memory unit, or writing a modified iSCSI protocol data unit to the read memory unit;
a DMA control signal port, receiving the data of the DMA controller and transmitting the response data to the DMA controller; and
a CRC register file, storing the state and setting of the CRC control module.

7. The direct memory access system according to claim 6, wherein the CRC control module further comprises:
a plurality of comparators, judging whether to calculate the cyclic redundancy codes or not;
a CRC replacement circuit, replacing the header digest or data digest in the iSCSI protocol data unit with the cyclic redundancy codes under an Tx mode; and
a CRC comparator circuit, comparing the CRC with the header digests or the data digests in the iSCSI protocol data unit under an Rx mode.
